(19) United States
(12) Patent Application Publication
(10) Pub. No.: US 2022/0100329 A1
(43) Pub. Date: Mar. 31, 2022

(54) SYSTEM FOR SELECTION AND DISPLAY OF SYNDICATED CONTENT

(71) Applicants: Itzhak SHRIKI, Herzliya (IL); Ben GARRUN, Ramat Hasharon (IL)

(72) Inventors: Itzhak SHRIKI, Herzliya (IL); Ben GARRUN, Ramat Hasharon (IL)

(21) Appl. No.: 17/039,750

(22) Filed: Sep. 30, 2020

(51) Int. Cl. G06F 3/0482

(52) U.S. Cl. CPC G06F 3/0482

(57) ABSTRACT

A computerized system providing a first user interface and a web-browser toolbar-based user interface of navigating syndicated content, comprising a processing circuitry operably connectable to a display device, the processing circuitry being configured to generate and display, on the display device: a) a first user interface of summary item navigation configured to display syndicated summary items that are indicative of a respective content item that is displayable in a web browser, in accordance with at least one shared updatable summary items state, and b) a web browser toolbar-based user interface of summary item navigation configured to display the one or more syndicated summary items in accordance with the at least one shared updatable summary items state, thereby providing a user with a persistent view of syndicated content items during passive monitoring of the content items, navigation of the content items, and viewing of the content items in a web browser.

### TECHNICAL FIELD

The presently disclosed subject matter relates to syndicated Internet content, and in particular to systems of selecting and displaying such content.

### BACKGROUND

Problems of distributing, presenting, selecting and displaying both syndicated and curated World Wide Web content have been recognized in the conventional art and various techniques have been developed to provide solutions.

### GENERAL DESCRIPTION

According to one aspect of the presently disclosed subject matter there is provided a computing system providing a first user interface and a web-browser toolbar-based user interface of navigating syndicated content, the system comprising:
a processing circuitry comprising a processor and memory, and operably connectable to a display device, the processing circuitry being configured to generate and display, on the display device:
   a. a first user interface of summary item navigation, the user interface configured to:
      display one or more syndicated summary items, wherein at least one of the syndicated summary items is indicative of a respective content item that is displayable in a web browser,
         the displaying of the one or more syndicated summary items being in accordance with at least one shared updatable summary items state, and
      responsive to a user operation associated with at least one of the one or more displayed summary items, display, in a web browser, at least one respective content item; and
   b. a web browser toolbar-based user interface of summary item navigation, the user interface configured to:
      display the one or more syndicated summary items in accordance with the at least one shared updatable summary items state, and
      responsive to a user operation associated with at least one of the one or more displayed summary items, display, in a web browser, at least one respective content item;
         thereby providing a user with a persistent view of syndicated content items during passive monitoring of the content items, navigation of the content items, and viewing of the content items in a web browser.

In addition to the above features, the system according to this aspect of the presently disclosed subject matter can comprise one or more of features (i) to (xi) listed below, in any desired combination or permutation which is technically possible:

(i) the displaying the one or more syndicated summary items by the web browser toolbar-based user interface comprises:
displaying summary item data, responsive to a user operation that is selected from a list comprising:
a) clicking on a toolbar item; and
b) mouseover of a toolbar item.
   (ii) the at least one shared updatable summary items state comprises a currently selected summary item, and
   each of the interfaces is further configured to display the summary items in accordance with the currently selected summary item.
   (iii) at least one of the interfaces is further configured to:
   responsive to a user operation associated with selecting a specific summary item of the one or more summary items, update the currently selected summary item.
   (iv) the at least one updatable summary items state comprises a currently selected category of summary items, and
each of the interfaces is further configured to display the summary items in accordance with:
   a) a categorization of summary items into at least two categories, and
   b) the currently selected category of summary items.
      (v) at least one of the user interfaces is further configured to:
responsive to a user operation associated with selecting a category of summary items, update the currently selected category.
   (vi) the at least one updatable summary items state comprises a currently selected subcategory of summary items, and
   each of the interfaces is further configured to display the summary items in accordance with:
a) a subcategorization of summary items of the currently selected category into at least two subcategories, and
b) the currently selected subcategory of summary items.
   (vii) at least one of the interfaces is further configured to:
responsive to a user operation associated with selecting a subcategory of summary items, update the currently selected subcategory.
   (viii) the at least one updatable summary items state comprises, for at least one summary item of the one or more summary items, data indicative of whether the respective summary item has been viewed by a user, and
   each of the interfaces is further configured to display the at least one summary item in accordance with whether it has been viewed.
   (ix) at least one of the interfaces is further configured to:
responsive to a user operation associated with viewing a summary item, update the data indicative of whether the respective summary item has been viewed.
   (x) the processing circuitry is configured to receive summary items via a syndication protocol.
   (xi) the processing is configured to receive summary items from a local retrieval client.

According to another aspect of the presently disclosed subject matter there is provided a method of providing a user with a persistent view of syndicated content items, the method comprising:
a) generating and displaying, by a processing circuitry, on a display device, a first user interface of summary item navigation, wherein
   (i) the first user interface displays one or more syndicated summary items,
   (ii) at least one of the syndicated summary items is indicative of a respective content item that is displayable in a web browser, and
   (iii) the displaying of the one or more syndicated summary items is in accordance with at least one shared updatable summary items state;
b) responsive to a user operation associated with at least one of the one or more displayed syndicated summary items, displaying, by the processing circuitry, in a web browser, at least one respective content item; and
c) generating and displaying, by the processing circuitry, on the web browser, a toolbar-based user interface of summary item navigation, wherein:
   the toolbar-based user interface displays the one or more syndicated summary items in accordance with the at least one shared updatable summary items state, and
   the toolbar-based user interface is configured to display, responsive to a user operation associated with at least one of the one or more displayed summary items, in a web browser, at least one respective content item,

thereby providing a user with a persistent view of syndicated content items during passive monitoring of the content items, navigation of the content items, and viewing of the content items in a web browser.

According to another aspect of the presently disclosed subject matter there is provided a method of providing a user with a persistent view of syndicated content items, the method comprising:
a) generating and displaying, by a processing circuitry, on a web browser on the display device, a toolbar-based user interface of summary item navigation, wherein:
   (i) the toolbar-based user interface displays one or more syndicated summary items,
   (ii) at least one of the syndicated summary items is indicative of a respective content item that is displayable in a web browser, and
   (iii) the displaying of the one or more syndicated summary items is in accordance with at least one shared updatable summary items state, and
   (iv) the toolbar-based user interface is configured to display, responsive to a user operation associated with at least one of the one or more displayed summary items, in a web browser, at least one respective content item.
b) responsive to a user operation, generating and displaying, by the processing circuitry, on a display device, a first user interface of summary item navigation, wherein:
   associated with at least one of the one or more displayed syndicated summary items, displaying, by the processing circuitry, in a web browser, at least one respective content item; and
thereby providing a user with a persistent view of syndicated content items during passive monitoring of the content items, navigation of the content items, and viewing of the content items in a web browser.

This aspect of the disclosed subject matter can optionally comprise one or more of features (i) to (xi) listed above with respect to the system, mutatis mutandis, in any desired combination or permutation which is technically possible.

According to another aspect of the presently disclosed subject matter there is provided a computer program product comprising a non-transitory computer readable storage medium retaining program instructions, which, when read by a processing circuitry, cause the processing circuitry to perform a computerized method of providing a user with a persistent view of syndicated content items, the method comprising:
a) generating and displaying, by a processing circuitry, on a display device, a first user interface of summary item navigation, wherein:
   (i) the first user interface displays one or more syndicated summary items,
   (ii) at least one of the syndicated summary items is indicative of a respective content item that is displayable in a web browser, and
   (iii) the displaying of the one or more syndicated summary items is in accordance with at least one shared updatable summary items state;
b) responsive to a user operation associated with at least one of the one or more displayed syndicated summary items, displaying, by the processing circuitry, in a web browser, at least one respective content item; and
c) generating and displaying, by the processing circuitry, on the web browser, a toolbar-based user interface of summary item navigation, wherein:
   the toolbar-based user interface displays the one or more syndicated summary items in accordance with the at least one shared updatable summary items state, and
   the toolbar-based user interface is configured to display, responsive to a user operation associated with at least one of the one or more displayed summary items, in a web browser, at least one respective content item,
thereby providing a user with a persistent view of syndicated content items during passive monitoring of the content items, navigation of the content items, and viewing of the content items in a web browser.

This aspect of the disclosed subject matter can optionally comprise one or more of features (i) to (xi) listed above with respect to the system, mutatis mutandis, in any desired combination or permutation which is technically possible.

According to another aspect of the presently disclosed subject matter there is provided a computer program product comprising a non-transitory computer readable storage medium retaining program instructions, which, when read by a processing circuitry, cause the processing circuitry to perform a computerized method of providing a user with a persistent view of syndicated content items, the method comprising:
a) generating and displaying, by a processing circuitry, on a web browser on the display device, a toolbar-based user interface of summary item navigation, wherein:
   (i) the toolbar-based user interface displays one or more syndicated summary items,
   (ii) at least one of the syndicated summary items is indicative of a respective content item that is displayable in a web browser, and
   (iii) the displaying of the one or more syndicated summary items is in accordance with at least one shared updatable summary items state, and
   (iv) the toolbar-based user interface is configured to display, responsive to a user operation associated with at least one of the one or more displayed summary items, in a web browser, at least one respective content item.
b) responsive to a user operation, generating and displaying, by the processing circuitry, on a display device, a first user interface of summary item navigation, wherein:
   associated with at least one of the one or more displayed syndicated summary items, displaying, by the processing circuitry, in a web browser, at least one respective content item; and
   thereby providing a user with a persistent view of syndicated content items during passive monitoring of the content items, navigation of the content items, and viewing of the content items in a web browser.

This aspect of the disclosed subject matter can optionally comprise one or more of features (i) to (xi) listed above with respect to the system, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1 illustrates an example prior art system of providing syndicated content to a user;

FIG. 2 illustrates a flow diagram describing an example prior art method for providing syndication data and related web content to a user;

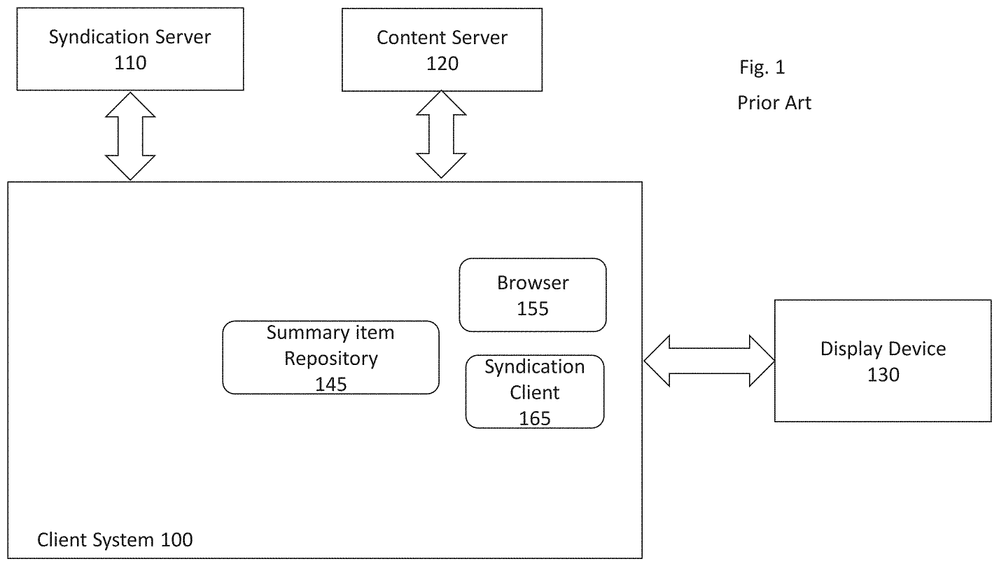

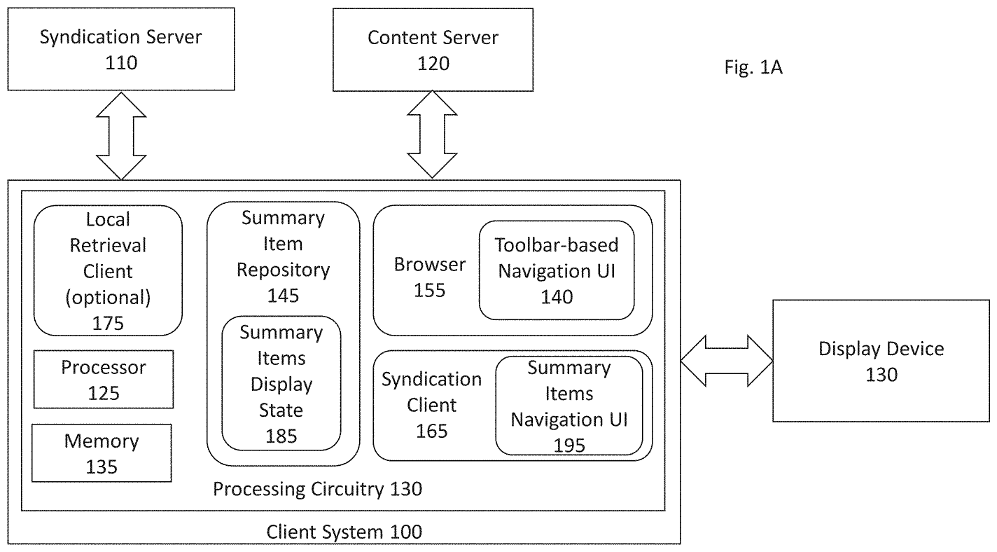

FIG. 1A illustrates a logical block diagram of an example system of providing syndicated content to a user via an improved device interface, in accordance with some embodiments of the presently disclosed subject matter;

FIG. 3A illustrates an example screen displaying a syndicated summary items navigation user interface to a user, in accordance with some embodiments of the presently disclosed subject matter;

FIG. 3B illustrates an example summary items navigator user interface with its example components, in accordance with some embodiments of the presently disclosed subject matter;

FIG. 3C illustrates an example computer screen display showing a web browser including a toolbar-based syndicated summary items display interface with its example components, in accordance with some embodiments of the presently disclosed subject matter;

FIG. 3D illustrates an example computer screen display showing a web browser including a display toolbar-based syndicated summary items display interface with its example components including a display of summary items, in accordance with some embodiments of the presently disclosed subject matter; and

FIG. 4 illustrates a flow diagram of an example behavior of a system of providing syndicated content, in accordance with some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “determining”, “calculating”, “receiving”, “providing”, “obtaining”, “generating”, “displaying”, “invoking” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

Bearing the above in mind, attention is now directed to FIG. 1, which depicts an example prior art system of providing syndicated content to a user.

Since the inception of the world wide web (WWW), much of the content on the Internet has been organized and distributed according to a scheme where clients transmit requests to servers for specific data (i.e. a “pull model”). More specifically: users can utilize client devices (e.g. laptop computer, desktop computer, tablet, smartphone etc.) which incorporate client applications such as web-browsers or applications with web-browser-like functionality. The applications can use a protocol such as Hypertext Transfer Protocol (HTTP) to request a particular resource (e.g. multimedia data described for example using a Uniform Resource Locator (URL)) which is maintained on a server and then transmitted by that server to the client.

This familiar client-request centered method (or “pull model”), can be augmented using a technology known as syndication—which can be said to provide a “push model” for distribution of content. Syndication protocols such as Really Simple Syndication (RSS) or applications such as Telegram™ can distribute summaries of content to users as the content becomes available—for example in response to a user subscription request indicating a desire to receive a “feed” of a particular type of content. The distributed (i.e. “syndicated”) summary data can include URL(s) which provide additional related content (e.g. web content accessible in a usual fashion via a web browser).

In the example system illustrated in FIG. 1, client system 100 can be a suitable type of processor-based device. Client system 100 can be operably connected to a display device 130 (e.g. monitor) on which it displays data. Client system 100 can also be in communication with content server 120 and syndication server 110 (for example via an Internet connection).

Syndication server 110 can be a server located on the Internet which distributes content via a syndication protocol such as—for example—RSS. Content server 120 can be a server located on the Internet which returns content in response to requests via HTTP. In some cases, syndication server 110 and content server 120 can be the same server e.g. content server 120 can also transmit or make available feeds containing summaries of content items In other cases, syndication server 110 and content server 120 can be distinct e.g. syndication server 110 can monitor content server 120 and can transmit or make available feeds containing summaries of content items.

It is noted that for simplicity FIG. 1 illustrates a single syndication server 110 and single content server 120. It is further noted than in other examples there can be multiple content servers 120 and/or multiple syndication servers 110.

Syndication client 165 can be a software module and can utilize a syndication protocol such as RSS to receive syndicated summaries of content maintained on content server 120 (hereforward termed “summary items”) from syndication server 110. Summary item repository 145 can be a suitable type of software database or data repository and can be used to store the summary items received by syndication client 165. Syndication client 165 can also present summary items to the user on display device 130. A user can access URLs associated with the presented summary items by using browser 155.

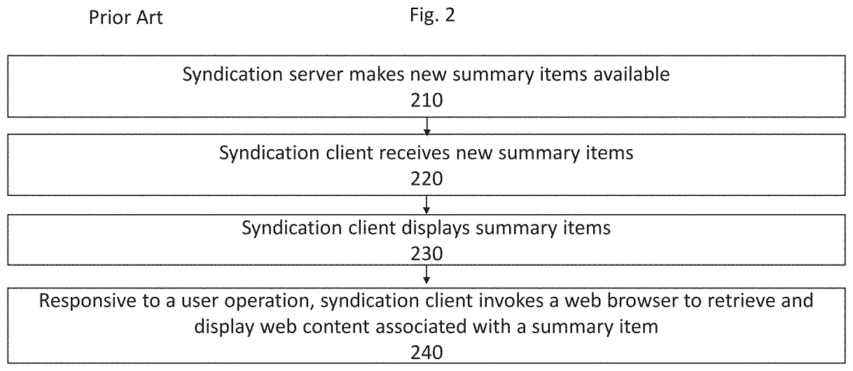

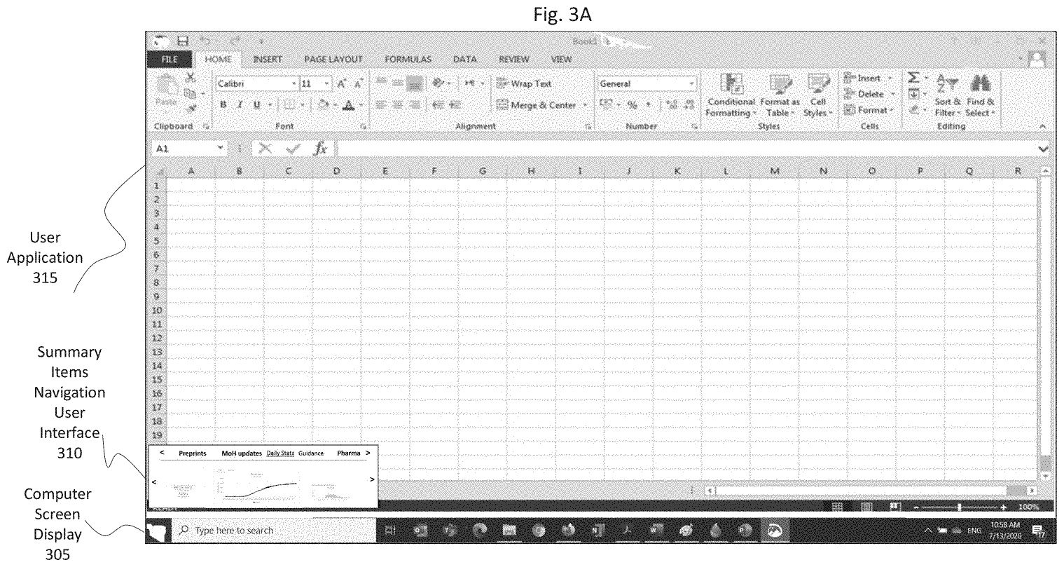

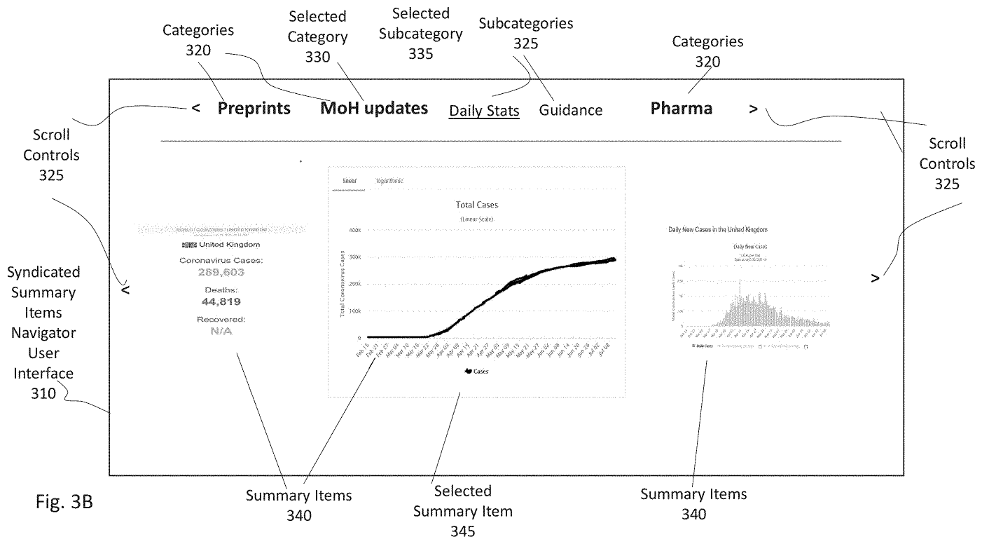

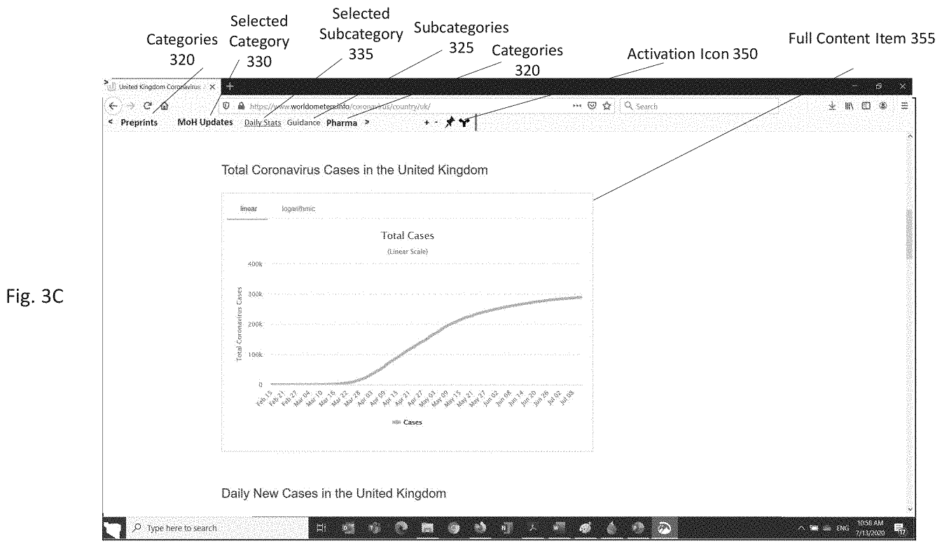

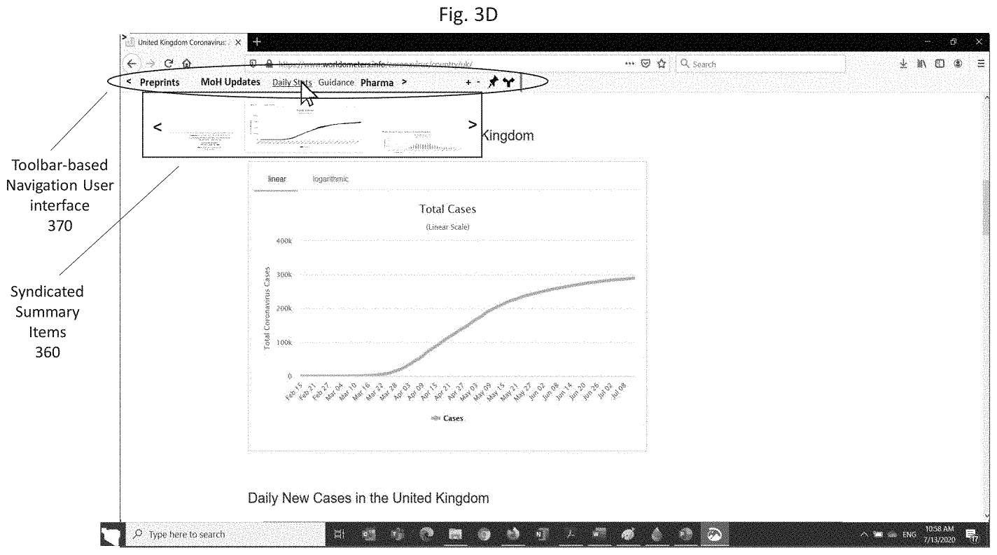

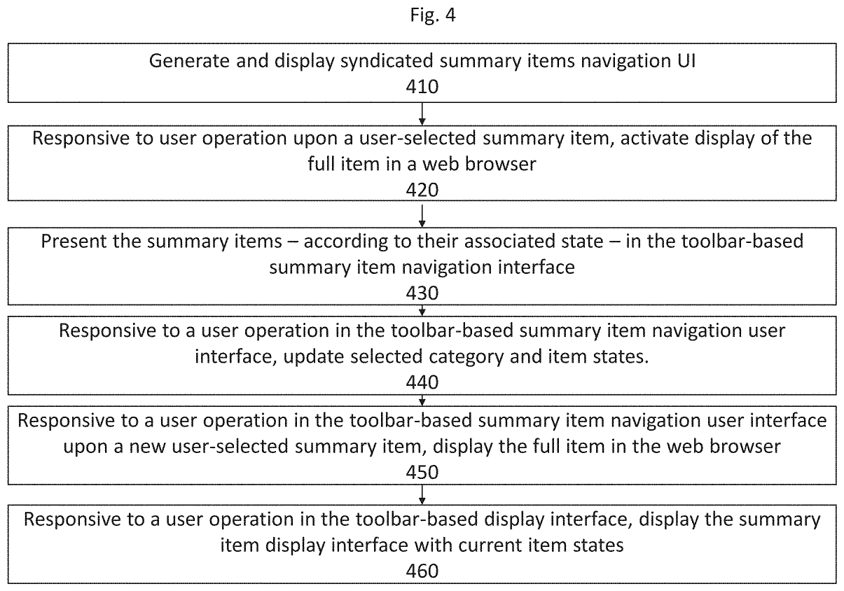

FIG. 2 illustrates a flow diagram describing an example prior art method for providing syndication data and related web content to a user. For clarity, the ensuing description of the method refers to components of the system described above with reference to FIG. 1.

Syndication server 110 can make available (210) new summary items. For example: there can be newly produced or newly aggregated content on content server 120, and syndication server 110 can make available the summary items describing this content (each summary item can include associated URL(s) providing additional content). In some examples, syndication server 110 will provide an extensible markup language (XML) file including the summary items to client devices (such as client system 100) which request it via a network connection using RSS or a similar protocol. In some examples, syndication server 110 transmits the summary items to client systems (such as client system 100) which had previously subscribed to the content.

Client 100 (for example: syndication client 165) can receive new summary items from the syndication server 110 (for example: by receiving an XML file including the summary items). In some examples, client 100 (for example: syndication client 165) can store the summary items to summary item repository 145.

Client 100 (for example: syndication client 165) can display (230) the new summary items (and possibly also old summary items) to the user.

Details of what is displayed can depend on the implementation of client 100 (for example: syndication client 165)—as is known in the art. In some examples, client 100 (for example: syndication client 165) displays all summary items in full. The display can include text, images, multimedia or other content, and can include clickable links to web content of an associated URL.

In some other examples, client 100 (for example: syndication client 165) displays a subset of the summary items in full (e.g. the most recently received item) while displaying a short text excerpt of the other summary items. In some such examples, client 100 (for example: syndication client 165) is configured so that a user operation can select a different summary item for display.

Responsive to a user operation (e.g. clicking on a URL in a display of a summary item), client 100 (for example: syndication client 165) can then invoke (240) a web browser to display the summary item's associated web content to the user.

Attention is now directed to FIG. 1A, which illustrates a logical block diagram of an example system of providing syndicated content to a user via an improved device interface, in accordance with some embodiments of the presently disclosed subject matter.

Client system 100 can include processing circuitry 130. In some embodiments, processing circuitry 130 includes a processor 125 and memory 135.

Processor 125 can be a suitable hardware-based electronic device with data processing capabilities, such as, for example, a general purpose processor, digital signal processor (DSP), a specialized Application Specific Integrated Circuit (ASIC), one or more cores in a multicore processor etc. Processor 125 can also consist, for example, of multiple processors, multiple ASICs, virtual processors, combinations thereof etc.

Memory 135 can be, for example, a suitable kind of volatile and/or non-volatile storage, and can include, for example, a single physical memory component or a plurality of physical memory components. Memory 135 can also include virtual memory. Memory 135 can be configured to, for example, store various data used in computation.

Processor 125 can be configured to execute several functional modules in accordance with computer-readable instructions implemented on a non-transitory computer-readable storage medium. Such functional modules are referred to hereinafter as comprised in the processor. These modules can include, for example, summary item repository 145, browser 155, toolbar user interface 140, syndication client 165, summary items navigator 195, and (optional) local retrieval client 175.

Syndication client 165 can receive data indicative of summary items from syndication server 110. The summary items can include text, image data, multimedia etc. as well as data indicative of a URL providing additional associated content.

Syndication client 165 can further receive metadata associated with the summary items. The metadata can include originating server, timestamp of origin, identification of the feed/subscription/channel from which the summary item was received, etc.

Syndication client 165 can store summary items and metadata to summary item repository 145 and can also retrieve the summary items and metadata.

Syndication client 165 can be configured to generate and display—on display device 130 (e.g. monitor)—syndicated summary item navigation user interface 195. In some embodiments, syndicated summary item navigation user interface 195 is a user interface that is configured to display one or more syndicated summary items, wherein at least one of the syndicated summary items is indicative of a respective content item that is displayable in a web browser.

As will be detailed below, and illustrated below with reference to examples in FIG. 3A-3D, syndicated summary item navigation user interface 195 can be configured to display the summary items in accordance with certain metadata—such as time received or originating feed. Syndicated summary item navigation user interface 195 can also be configured to display the summary items in accordance with certain updateable state information—such as the particular feed (or item category) that a user is viewing, and which items have been already viewed. Hereforward, such an item of updatable state information pertaining to summary items is termed an “updatable summary items state”. An updatable summary items state that is used by more than one user interface is herein termed a “updatable summary items state”.

For example: the syndicated summary item navigation user interface 195 can display summary items in accordance with a summary item ordering. In some embodiments, the syndicated summary item navigation user interface 195 displays the summary items in accordance with a summary item ordering derived from the summary item metadata (for example: the user interface can display the items from oldest-to-newest or newest-to-oldest). In some other embodiments, the syndicated summary item navigation user interface 195 displays the summary items in accordance with a different summary item ordering. In some other embodiments, the syndicated summary item navigation user interface 195 displays a summary of items separately for each category/subcategory, each category/subcategory having a summary item ordering.

The syndicated summary item navigation user interface 195 can display the summary items in accordance with a summary item categorization. In some embodiments, syndicated summary item navigation user interface 195 displays the summary items in accordance with a summary item categorization derived from the summary item metadata. In some other embodiments, syndicated summary item navigation user interface 195 displays the summary items in accordance with a different summary item categorization. In some embodiments, syndicated summary item navigation user interface 195 displays the summary items in accordance with a summary item subcategorization within the category (for example: the user interface can display the items in separate listings depending the RSS feed and specific RSS feed from which they originate—see for example in FIG. 3D below). In some embodiments, summary item navigation user interface 195 displays one or more syndicated summary items in accordance with at least one updatable summary items state.

The syndicated summary item navigation user interface 195 can display summary items in accordance with whether or not the summary item has been viewed by a user (for example: by displaying unread items using a different font or different color scheme from read items). Whether or not each summary item has been viewed by the user can be part of the updateable state information. Syndicated summary item navigation user interface 195 can store this updateable state information to summary items display state module 185. Syndicated summary item navigation user interface 195 can also read this updateable state information from summary items display state module 185.

Syndicated summary item navigation user interface 195 can, responsive to a user operation associated with viewing a summary item, update the updateable summary item state information indicative of whether the respective summary item has been viewed.

The syndicated summary item navigation user interface 195 can display summary items in accordance with a currently selected summary items category (for example: by displaying items of a category selected by the user, while hiding items of other categories). The syndicated summary item navigation user interface 195 can display summary items in accordance with a currently selected summary items subcategory (for example: by displaying items of a subcategory selected by the user, while hiding items of other categories and other subcategories, see for example FIG. 3D). Syndicated summary item navigation user interface 195 can store this updateable state information to summary items display state module 185. Syndicated summary item navigation user interface 195 can also read this updateable state information from summary items display state module 185.

Syndicated summary item navigation user interface 195 can, responsive to a user operation associated with updating the currently selected summary items category, update the currently selected summary items category of the updateable state information. Syndicated summary item navigation user interface 195 can, responsive to a user operation associated with updating the currently selected summary items subcategory, update the currently selected summary items subcategory of the updateable state information.

The syndicated summary item navigation user interface 195 can display summary items in accordance with a currently selected summary item (for example: by displaying the summary item currently selected by the user so that it is larger than other items—as shown for example below with reference to FIG. 3D). Syndicated summary item navigation user interface 195 can store this updateable state information to summary items display state module 185. Syndicated summary item navigation user interface 195 can also read this updateable state information from summary items display state module 185.

Syndicated summary item navigation user interface 195 can, responsive to a user operation associated with updating the currently selected summary item, update the currently selected summary item of the updateable state information.

Syndicated summary item navigation user interface 195 can—responsive to a user operation associated with a summary item—invoke display of an associated full content item in a web browser.

Browser 155 can be a suitable type of web browsing application such as Microsoft™ Edge™, Google™ Chrome™ etc. Browser 155 can also be another type of suitable application for retrieving and displaying content. Browser 155 can include a toolbar-based navigation user interface 140 that is configured to display syndicated summary items in accordance with the updatable summary items state information.

Toolbar-based navigation user interface 140 can be located on a toolbar portion of the browser—for example an area of application real estate in many browsers which is often located below the input box of the browser and above the web page display area (see for example FIG. 3D below). Toolbar-based navigation user interface 140 can also be located in any other appropriate location.

In some embodiments, toolbar-based navigation user interface 140 displays summary item data in response to a user operation such as:

a) clicking on a toolbar item (e.g. toolbar text or toolbar icon)

b) mouseover of the toolbar item.

See for example FIG. 3D below.

Toolbar-based navigation user interface 140 can display summary items in accordance with one or more updatable summary item states. For example: toolbar-based navigation user interface 140 can display summary items in accordance with the following updatable summary item states as described above for the syndicated summary item navigation user interface 195:

a) whether or not the summary item has been viewed by a user

b) currently selected summary items category

c) currently selected summary items subcategory

d) currently selected summary item

In some embodiments, toolbar-based navigation user interface 140 can, responsive to a user operation associated with an updatable summary item state, update the respective state. For example: Toolbar-based navigation user interface 140 can update one or more of updatable summary item states a)-d) responsive to a user operation, as described above for the syndicated summary item navigation user interface 195.

The display of the summary items in accordance with the updatable summary items state information by toolbar-based navigation user interface 140 can provide a user with a persistent view of syndicated content items during passive monitoring of the content items, navigation of the content items, and viewing of the content items in a web browser.

Browser 155 can—responsive to a user operation associated with a summary item in the toolbar-based user interface—display an associated full content item.

Summary item repository 145 can be any kind of suitable data store. Summary item repository 145 can store summary items (e.g. received by syndication client 165). Summary item repository 145 can include summary items display state module 185.

Summary items display state module 185 can store and maintain display state information pertaining to summary items e.g. selected category, selected subcategory, selected summary item etc.

In some embodiments, optional local retrieval client 175 can perform functions of a syndication server. For example, local retrieval client 175 can be an HTTP client which spiders websites, retrieves content, and prepares summary items (for example: with associated URLs indicating browsable full items). Such summary items are regarded as syndicated summary items.

The improved device interface provided by systems in accordance with some embodiments of the presently disclosed subject matter—for example as described with reference to FIG. 1A—can have advantages over prior art systems and methods.

For example: in the prior art method of retrieval of web-based content associated with syndicated summary items described above with reference to FIG. 2, the reception, display, and selection of the syndicated summary items is—from the user perspective—a series of steps distinct from the retrieval and display of the web content. Accordingly, in the prior art method described above with reference to FIG. 2, a user utilizing syndicated feeds is required to alternate between viewing summary items via syndication client 165 and viewing associated item content in browser 155—e.g. by switching back and forth between applications. Moreover, the user can be required to visually reorient/refocus on the displayed summary items each time that he/she returns to view syndication client 165.

In some embodiments of the currently described subject matter, a user can utilize the summary items navigator user interface for passive monitoring of syndicated feed data (e.g. passive user monitoring of the navigator user interface for arrival of new items while actively performing another activity). Similarly, a user can utilize the summary items navigator user interface due to other features it might have as described hereinbelow (e.g. screen real estate, features etc.). The user can then invoke a web browser to display full content associated with a summary item. Toolbar extensions to the web browser can then enable continued display and utilization of the summary item data with its navigation context (e.g. selected subcategory etc.) within the web browser, thereby enabling the user to continue accessing syndicated/curated content in accordance with the structure and the state information of the summary items. Moreover, a further toolbar extension can restore display of the summary items display client. These aspects are described in detail hereinbelow with reference to FIG. 4.

It is further noted that a system providing only toolbar-based navigation of summary items can be unsuited to passive monitoring of syndicated feeds (as a web browser can require comparatively large screen real estate, and can require clicks/mouseovers for summary item display, and can lack features/usability available in navigation interfaces that are not part of a browser toolbar).

It is noted that the teachings of the presently disclosed subject matter are not bound by the system described with reference to FIG. 1A. Equivalent and/or modified functionality can be consolidated or divided in another manner and can be implemented in any appropriate combination of software with firmware and/or hardware and executed on a suitable device. The client system (100) can be a standalone entity, or integrated, fully or partly, with other entities.

Attention is now directed to FIG. 3A, which depicts an example screen displaying a syndicated summary items navigation user interface to a user, in accordance with some embodiments of the presently disclosed subject matter.

FIG. 3A depicts an example of a computer screen display 305. The screen display 305 includes a syndicated summary items navigation user interface 310, and a user application 315. It is noted that the arrangement of screen display 305 enables a user to be actively engaged with user application 315 while passively monitoring syndicated summary items navigation user interface 310 for arrival of new summary items (for example: high-priority data which the user wants to review immediately upon availability). When new summary items appear in syndicated summary items navigation user interface 310 the user can choose to engage with the new items (e.g. by invoking display of associated content in a web browser).

Attention is now directed to FIG. 3B, which depicts a detailed example of syndicated summary items navigation user interface 310 with its example components in accordance with some embodiments of the presently disclosed subject matter.

In some embodiments, summary items navigator interface 310 can display one or more summary item categories 320. In the example shown in FIG. 3B, the categories 320 include: “Preprints”, “MoH Updates”, and “Pharma”.

In some embodiments, a certain number of summary item categories 320 are shown on syndicated summary items navigation user interface 310, and scroll controls 325 enable scrolling to different summary item categories.

In some embodiments, a certain category can have a status of being a “selected” category 330. In the example shown in FIG. 3B, “MoH Updates” is the selected category 330. In some embodiments, syndicated summary items user interface 310 displays summary item subcategories 325 of the selected summary item category 330. In some embodiments, a user can select a summary item category in the syndicated summary items navigation user interface 310 via user operation such as mouse click, key sequence etc. In some embodiments, syndicated summary items navigation user interface 310 can automatically select a summary item category—for example: upon arrival of new summary items in the category.

In some embodiments, syndicated summary items navigation user interface 310 can display one or more summary item subcategories 325. In the example shown in FIG. 3B, the subcategories 325 of the MoH Updates category includes: “Daily Stats”, and “Guidance”. In some embodiments, a user can select a summary item subcategory in the syndication summary items navigation user interface 310 via user operation such as mouse click, key sequence etc. In some embodiments, syndicated summary items navigation user interface 310 can automatically select a summary item subcategory—for example: upon arrival of new summary items in the subcategory.

In some embodiments, the summary item category is derived from a grouping of syndication feeds. In some embodiments, the summary item subcategory is derived from the particular syndication feed.

In some embodiments, syndicated summary items navigation user interface 310 can display one or more summary items 340. The displayed summary items 340 can include text, graphics, multimedia, embedded URLs etc.

In some embodiments, syndicated summary items navigation user interface 310 displays summary items 340 in accordance with a summary item ordering (e.g. newest to oldest). In some embodiments, a certain number of summary items are shown on syndicated summary items navigation user interface 310, and scroll controls 325 enable scrolling to different summary items. In some embodiments, a user can select a summary item ordering (e.g. oldest-to-newest, newest-to-oldest etc.) in the syndicated summary items navigation user interface 310 via user operation such as mouse click, key sequence etc. In some embodiments, syndicated summary items navigation user interface 310 can automatically select a summary item ordering—for example: upon arrival of a new summary item.

In some embodiments which display summary item categories (or summary item categories with subcategories), syndicated summary items navigation user interface 310 displays summary items that belong to the selected category (or to the selected category and selected subcategory).

In some embodiments, a certain summary item can have a status of being a “selected” summary item 345. In the example shown in FIG. 3B, the image labelled “Total Cases” is the selected summary item 345, and it is displayed larger than other summary items 340. In some embodiments, a user can select a summary item in the syndicated summary items navigation user interface 310 via user operation such as mouse click, key sequence etc. In some embodiments, syndicated summary items navigation user interface 310 can automatically select a summary item—for example: upon arrival of new summary items.

In some embodiments, a user can instruct syndicated summary items navigation user interface 310 to invoke a web browser to display a URL that is associated with a particular summary item. For example, the user can select the particular summary item, and then perform a user operation (e.g. mouse click, key sequence etc.) to invoke the web browser to display the URL.

Attention is now directed to FIG. 3C, which depicts an example computer screen display showing a web browser including toolbar-based syndicated summary items navigation user interface with its example components, in accordance with some embodiments of the presently disclosed subject matter.

In some embodiments, the view of the web browser in FIG. 3C can result—for example—from a user selecting a summary item in syndicated summary items navigation user interface 310 and performing a user operation to view the full content item 355 in the web browser.

In some embodiments, toolbar-based syndicated summary items navigation user interface can display one or more of the summary item categories 320 displayed by syndicated summary items display interface 310 (for example: all of the summary item categories).

In some embodiments, toolbar-based syndicated summary items navigation user interface can display a summary item category as a selected category 330 (for example: the selected category as displayed by syndicated summary items display interface 310).

In some embodiments, toolbar-based syndicated summary items navigation user interface can display one or more of the summary item subcategories 325 displayed by syndicated summary items display interface 310 (for example: all of the summary item subcategories).

In some embodiments, toolbar-based syndicated summary items navigation user interface can display a summary item subcategory as a selected subcategory 335 (for example: the selected subcategory as displayed by syndicated summary items display interface 310).

In some embodiments, a user can select a summary item category in the toolbar-based syndicated summary items navigation user interface via a user operation such as a mouse click, key sequence etc.

In some embodiments, a user can select a summary item subcategory in the toolbar-based syndicated summary items navigation user interface via a user operation such as a mouse click, key sequence etc.

In some embodiments, a user can trigger display of the syndicated summary items navigation user interface 310 from the toolbar-based syndicated summary items navigation user interface via a user operation such as a mouse click on activation icon 350, key sequence etc.

In some embodiments, the selected summary category and/or selected summary item subcategory selected by the user in the toolbar-based syndicated summary items navigation user interface can be displayed subsequently in syndicated summary items navigation user interface 310, thereby enabling the user to continue viewing summary items in accordance with the structure and the state information of the summary items.

Attention is now directed to FIG. 3D, which depicts an example computer screen display showing a web browser including toolbar-based syndicated summary items navigation user interface 370 with its example components including a display of syndicated summary items 360, in accordance with some embodiments of the presently disclosed subject matter.

In some embodiments, the view of the web browser in FIG. 3D can result—for example—from a user selecting a summary item in syndicated summary items navigation user interface 310 and performing a user operation to view the full item in the web browser, and subsequently placing a user cursor (e.g. mouseover) over a subcategory in the toolbar-based syndicated summary items display interface 370.

In some embodiments, toolbar-based syndicated summary items navigation user interface 370 can display one or more of the syndicated summary items 360 displayed by syndicated summary items navigation user interface 310 (for example: all of the summary items displayed by syndicated summary items navigation user interface 310).

In some embodiments, toolbar-based syndicated summary items navigation user interface 370 displays summary items 360 in accordance with a summary item ordering (for example: the summary item ordering utilized by syndicated summary items navigation user interface 310).

In some embodiments, toolbar-based syndicated summary items navigation user interface 370 displays a summary item as a selected summary item (for example: the selected summary item as displayed by syndicated summary items navigation user interface 310).

In some embodiments, a user can select a summary item ordering (e.g. oldest-to-newest, newest-to-oldest etc.) in the toolbar-based syndicated summary items navigation user interface 370 via user operation such as mouse click, key sequence etc.

In some embodiments, a user can select a summary item in the toolbar-based syndicated summary items navigation user interface 370 via a user operation such as mouse click, key sequence etc.

In some embodiments, a user can instruct toolbar-based syndicated summary items navigation user interface 370 to display a URL that is associated with a particular summary item. For example, the user can select the particular summary item, and then perform a user operation (e.g. mouse click, key sequence etc.) to trigger the web browser to display the URL.

In some embodiments, the selected summary item and/or selected summary item ordering selected by the user in the toolbar-based syndicated summary items navigation user interface 370 can be displayed subsequently in summary items navigation user interface 310, thereby enabling the user to continue viewing summary items in accordance with the structure and the state information of the summary items.

It is emphasized that the screens and user interfaces illustrated in FIGS. 3A-3D are for clarification of the presently disclosed subject matter and are not to be understood as limiting.

Attention is now directed to FIG. 4, which illustrates a flow diagram of an example behavior of a system of providing syndicated content, in accordance with some embodiments of the presently disclosed subject matter.

Syndication can be utilized for distributing and receiving up-to-date high priority information. For example: a syndication feed from a government ministry of health can provide health alerts (as has been done in some countries for distributing new Covid-19-related statistics and guidance). Similarly, researchers can use a syndication feed to make available a latest preprint to members of a subscribing research community. Syndication feeds can also be used for other types of content e.g. feeds of curated web-based news or other information.

Processing circuitry 130 (e.g. syndication client 165) can generate and display (410) syndicated summary item navigation user interface 310. Syndicated summary item navigation user interface 310 can display summary items (for example: summary items that are stored in summary item repository 145), and the summary items can be displayed in accordance with one or more shared updatable states (for example: information maintained in the summary items display state module 185).

Responsive to a user operation upon a user-selected summary item (e.g. clicking), processing circuitry 130 (e.g. syndicated summary item navigation user interface 195) can activate (420) display of the full item (e.g. by web browser 155).

Processing circuitry 130 (e.g. toolbar-based summary item navigation user interface 140) can then present (430) the summary items (e.g. from summary item repository 145) in toolbar-based summary item navigation user interface 370 in accordance with their current state (e.g. from information maintained in the summary items display state module 185).

Responsive to a user operation in the toolbar-based summary item navigation user interface (e.g. the user perusing additional summary items in additional categories and subcategories, selecting one of the summary items) processing circuitry 130 (e.g. web browser 155) can update (440) state information (for example in summary items display state module 185) accordingly.

Responsive to a user operation in the toolbar-based summary item navigation user interface 140 (e.g. the user performing an operation such as clicking on a summary item) processing circuitry 130 (e.g. web browser 155) can display (450) the full content item (for example: in a new browser tab).

Responsive to a user operation in the toolbar-based navigation user interface 140 (e. g. clicking on activation icon 350), processing circuitry 130 (e.g. syndication client 165) can display syndicated summary items navigation user interface 310. In some embodiments, syndicated summary items navigation user interface 310 displays summary items in accordance with state as updated by toolbar-based syndicated summary items navigation user interface 370 and as stored, for example, in summary items display state module 185.

It is noted that the teachings of the presently disclosed subject matter are not bound by the flow diagram illustrated in FIG. 4, and that in some cases the illustrated operations may occur concurrently or out of the illustrated order. It is also noted that whilst the flow chart is described with reference to elements of the system of FIG. 1A, this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computerized system providing a first user interface and a web-browser toolbar-based user interface of navigating syndicated content, the system comprising:
a processing circuitry comprising a processor and memory, and operably connectable to a display device, the processing circuitry being configured to generate and display, on the display device:
a) a first user interface of summary item navigation, the user interface configured to:
display one or more syndicated summary items, wherein at least one of the syndicated summary items is indicative of a respective content item that is displayable in a web browser,
the displaying of the one or more syndicated summary items being in accordance with at least one shared updatable summary items state, and
responsive to a user operation associated with at least one of the one or more displayed summary items, display, in a web browser, at least one respective content item; and
b) a web browser toolbar-based user interface of summary item navigation, the user interface configured to:
display the one or more syndicated summary items in accordance with the at least one shared updatable summary items state, and
responsive to a user operation associated with at least one of the one or more displayed summary items, display, in a web browser, at least one respective content item;
thereby providing a user with a persistent view of syndicated content items during passive monitoring of the content items, navigation of the content items, and viewing of the content items in a web browser.

2. The system of claim 1, wherein the displaying the one or more syndicated summary items by the web browser toolbar-based user interface comprises:
displaying summary item data, responsive to a user operation that is selected from a list comprising:
a) clicking on a toolbar item; and
b) mouseover of a toolbar item.

3. The system of claim 1,
wherein the at least one shared updatable summary items state comprises a currently selected summary item, and
wherein each of the interfaces is further configured to display the summary items in accordance with the currently selected summary item.

4. The system of claim 3, wherein at least one of the interfaces is further configured to:
responsive to a user operation associated with selecting a specific summary item of the one or more summary items, update the currently selected summary item.

5. The system of claim 1,
wherein the at least one updatable summary items state comprises a currently selected category of summary items, and
wherein each of the interfaces is further configured to display the summary items in accordance with:
a) a categorization of summary items into at least two categories, and
b) the currently selected category of summary items.

6. The system of claim 5, wherein at least one of the interfaces is further configured to:
responsive to a user operation associated with selecting a category of summary items, update the currently selected category.

7. The system of claim 5,
wherein the at least one updatable summary items state comprises a currently selected subcategory of summary items, and
wherein each of the interfaces is further configured to display the summary items in accordance with:
a) a subcategorization of summary items of the currently selected category into at least two subcategories, and
b) the currently selected subcategory of summary items.

8. The system of claim 7, wherein at least one of the interfaces is further configured to:
responsive to a user operation associated with selecting a subcategory of summary items, update the currently selected subcategory.

9. The system of claim 1,
wherein the at least one updatable summary items state comprises, for at least one summary item of the one or more summary items, data indicative of whether the respective summary item has been viewed by a user, and
wherein each of the interfaces is further configured to display the at least one summary item in accordance with whether it has been viewed.

10. The system of claim 9, wherein at least one of the interfaces is further configured to:
responsive to a user operation associated with viewing a summary item, update the data indicative of whether the respective summary item has been viewed.

11. The system of claim 1, wherein the processing circuitry is configured to receive summary items via a syndication protocol.

12. The system of claim 1, wherein the processing circuitry is configured to receive summary items from a local retrieval client.

13. A method of providing a user with a persistent view of syndicated content items, the method comprising:
a) generating and displaying, by a processing circuitry, on a display device, a first user interface of summary item navigation, wherein
(i) the first user interface displays one or more syndicated summary items,
(ii) at least one of the syndicated summary items is indicative of a respective content item that is displayable in a web browser, and
(iii) the displaying of the one or more syndicated summary items is in accordance with at least one shared updatable summary items state;
b) responsive to a user operation associated with at least one of the one or more displayed syndicated summary items, displaying, by the processing circuitry, in a web browser, at least one respective content item; and
c) generating and displaying, by the processing circuitry, on the web browser, a toolbar-based user interface of summary item navigation, wherein:
the toolbar-based user interface displays the one or more syndicated summary items in accordance with the at least one shared updatable summary items state, and
the toolbar-based user interface is configured to display, responsive to a user operation associated with at least one of the one or more displayed summary items, in a web browser, at least one respective content item;
thereby providing a user with a persistent view of syndicated content items during passive monitoring of the content items, navigation of the content items, and viewing of the content items in a web browser.

14. A computer program product comprising a non-transitory computer readable storage medium retaining program instructions, which, when read by a processing circuitry, cause the processing circuitry to perform a computerized method of providing a user with a persistent view of syndicated content items, the method comprising:
a) generating and displaying, by a processing circuitry, on a display device, a first user interface of summary item navigation, wherein:
(i) the first user interface displays one or more syndicated summary items,
(ii) at least one of the syndicated summary items is indicative of a respective content item that is displayable in a web browser, and
(iii) the displaying of the one or more syndicated summary items is in accordance with at least one shared updatable summary items state;
b) responsive to a user operation associated with at least one of the one or more displayed syndicated summary items, displaying, by the processing circuitry, in a web browser, at least one respective content item; and
c) generating and displaying, by the processing circuitry, on the web browser, a toolbar-based user interface of summary item navigation, wherein:
the toolbar-based user interface displays the one or more syndicated summary items in accordance with the at least one shared updatable summary items state, and
the toolbar-based user interface is configured to display, responsive to a user operation associated with at least one of the one or more displayed summary items, in a web browser, at least one respective content item,
thereby providing a user with a persistent view of syndicated content items during passive monitoring of the content items, navigation of the content items, and viewing of the content items in a web browser.

15. The computer program product of claim 14, wherein:
(i) the at least one shared updatable summary items state comprises a currently selected summary item,
(ii) the displaying the summary items by the first user interface is in accordance with the currently selected summary item, and
(iii) the displaying the summary items by the toolbar-based user interface is in accordance with the currently selected summary item.

16. The computer program product of claim 15, the method further comprising, subsequent to the displaying of one or more syndicated summary items by the first user interface:
responsive to a user operation associated with selecting a specific summary item of the one or more syndicated summary items, updating the currently selected summary item.

17. The system of claim 1, wherein the processing circuitry is further configured to:
responsive to a user operation in the web browser toolbar-based navigation user interface, display the syndicated summary items navigation user interface.
